(19) United States
(12) Patent Application Publication
(10) Pub. No.: US 2015/0081410 A1
(43) Pub. Date: Mar. 19, 2015

(54) CREATING AN AFFINITY RELATIONSHIP

(71) Applicant: BANK OF AMERICA CORPORATION, Charlotte, NC (US)

(72) Inventor: Erik Stephen Ross, Charlotte, NC (US)

(21) Appl. No.: 14/550,603

(22) Filed: Nov. 21, 2014

Related U.S. Application Data
(63) Continuation of application No. 13/360,400, filed on Jan. 27, 2012.
Application No. 13/360,400 is a continuation-in-part of application No. 13/109,565, filed on May 17, 2011.

(51) Int. Cl. G06Q 30/00; G06Q 30/02

(52) U.S. Cl. CPC G06Q 30/01; G06Q 30/0215; G06Q 30/0279
USPC 705/14.17

(57) ABSTRACT

Embodiments of the invention receive an expression of interest for a benefactor from a user, propose creation of an affinity program associated with the benefactor to the user, and create an affinity program associated with the benefactor. Creating includes determining at least one triggering action for triggering a donation to the benefactor, determining at least one potential participant for the affinity program, and inviting the at least one potential participant to join the affinity program. Creating the affinity may also include proposing the affinity program to the benefactor and negotiating contractual terms on behalf of a program administrator, such as, by using an artificial intelligence engine. In some embodiments, creating the affinity also includes, in response to determining the number of expressions of interest from unique users surpasses a predetermined threshold, initiating the affinity program by inviting at least one of the unique users to join the program.

### CROSS REFERENCE TO RELATED APPLICATION

This application is a continuation of co-pending U.S. application Ser. No. 13/360,400 entitled “Creating an Affinity Relationship” (filed Jan. 27, 2012), which published on Nov. 22, 2012 as U.S. Patent Application Publication No. 2012-0296731, which is a continuation-in-part of co-pending U.S. application Ser. No. 13/109,565 entitled “Tracking Donated Portion of Transaction,” (filed May 17, 2011), which published on Nov. 22, 2012 as U.S. Patent Application Publication No. 2012-0296809, which hereby incorporated by reference in its entirety.

### FIELD

In general, embodiments of the invention relate to systems related to affinity relationships. More specifically, embodiments of the invention relate to systems for creating an affinity relationship and program.

### BACKGROUND

Recently, the advent of rewards programs associated with banking accounts such as debit and/or credit accounts has provided incentive for customers of financial institutions to open such accounts associated with such rewards programs. Likewise, affinity programs, such as a program directed to providing a donation to a charitable organization of the customer's choice have been implemented and associated with banking accounts in order to incentivize the customer to open and maintain such accounts. In other instances, affinity programs support organizations or associations not necessarily characterized as charitable organizations such as professional associations, governments or municipalities such as counties or cities.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

According to embodiments of the invention, a method for creating an affinity program includes receiving an expression of interest for a benefactor from a user, proposing, by a processing device, creation of an affinity program associated with the benefactor to the user, and creating, by a processing device, an affinity program associated with the benefactor. Creating includes determining at least one triggering action for triggering a donation to the benefactor, determining at least one potential participant for the affinity program, and inviting the at least one potential participant to join the affinity program.

In some embodiments, creating the affinity program further comprises proposing the affinity program to the benefactor and negotiating contractual terms with the benefactor on behalf of a program administrator. In some such embodiments, an artificial intelligence engine negotiates the contractual terms on behalf of the program administrator. In other embodiments, the at least one potential participant is or includes the user.

In some embodiments, the benefactor has pre-established a plurality of affinity program creation rules and creating the affinity program also includes determining that a number of expressions of interest from unique users surpasses a predetermined threshold. In these embodiments, the instructions also include instruction for, in response to determining the number of expressions of interest from unique users surpasses the predetermined threshold, initiating the affinity program including initiating an invitation to at least one of the users to join the affinity program. In some such embodiments, the benefactor pre-established the plurality of affinity program rules by negotiating the plurality of affinity program rules with a program administrator.

In some embodiments, a program administrator has pre-established a plurality of affinity program creation rules and creating the affinity program also includes determining that a number of expressions of interest from unique users surpasses a predetermined threshold. The instructions also include instructions for, in response to determining the number of expressions of interest from unique users surpasses the predetermined threshold, initiating the affinity program, which includes initiating an invitation to at least one of the users to join the affinity program. In some such embodiments, the program administrator pre-established the plurality of affinity program rules by negotiating the plurality of affinity program rules with the benefactor.

In some embodiments, creating the affinity program also includes determining that a number of expressions of interest from unique users surpasses a predetermined threshold, and the method also includes proposing the affinity program to the benefactor and negotiating contractual terms with the benefactor on behalf of a program administrator. In some such embodiments, an artificial intelligence engine negotiates the contractual terms.

In some embodiments, creating the affinity program also includes receiving information indicating at least one interest of at least one of the potential participants and establishing a plurality of rules for governing the affinity program based at least in part on the received information. In some embodiments, the method also includes establishing a communication portal configured to receive at least one expression of interest or user recommendation regarding the affinity program.

In some embodiments, the method also includes establishing, by at least one of a plurality of potential participants or current participants, a communication portal configured to interact with the benefactor. In some such embodiments, the communication portal is configured to facilitate negotiation between the at least one potential or current participant and the benefactor.

According to embodiments of the invention, a system for creating an affinity program includes a processing device and a memory configured to store instructions for execution by the processing device. The instructions include instructions for receiving an expression of interest for a benefactor from a user, proposing creation of an affinity program associated with the benefactor to the user, and creating an affinity program associated with the benefactor. The instructions for creating include instructions for determining at least one triggering action for triggering a donation to the benefactor, determining at least one potential participant for the affinity program, and inviting the at least one potential participant to join the affinity program.

In some embodiments, creating the affinity program also includes proposing the affinity program to the benefactor and negotiating contractual terms with the benefactor on behalf of a program administrator. In some such embodiments, the instructions include an artificial intelligence engine configured for negotiating the contractual terms on behalf of the program administrator. In some embodiments, the at least one potential participant is or includes the user.

In some embodiments, the benefactor has pre-established a plurality of affinity program creation rules. The instructions for creating the affinity program also include instructions for determining that a number of expressions of interest from unique users surpasses a predetermined threshold, and the instructions also include instructions for, in response to determining the number of expressions of interest from unique users surpasses the predetermined threshold, initiating the affinity program. Initiating the affinity program includes instructions for initiating an invitation to at least one of the users to join the affinity program. In some such embodiments, the benefactor pre-established the plurality of affinity program rules by negotiating the plurality of affinity program rules with a program administrator.

In some embodiments, a program administrator has pre-established a plurality of affinity program creation rules, and the instructions for creating the affinity program also include instructions for determining that a number of expressions of interest from unique users surpasses a predetermined threshold. The instructions also include instructions for, in response to determining the number of expressions of interest from unique users surpasses the predetermined threshold, initiating the affinity program. The instructions also include instructions for initiating an invitation to at least one of the users to join the affinity program. In some such embodiments, the program administrator pre-established the plurality of affinity program rules by negotiating the plurality of affinity program rules with the benefactor.

In some embodiments, the instructions for creating the affinity program also include instructions for determining that a number of expressions of interest from unique users surpasses a predetermined threshold. The instructions also include instructions for proposing the affinity program to the benefactor and instructions for negotiating contractual terms with the benefactor on behalf of a program administrator. In some such embodiments, the instructions include an artificial intelligence engine configured for negotiating the contractual terms.

In some embodiments, the instructions for creating the affinity program also include instructions for receiving information indicating at least one interest of at least one of the potential participants and instructions for establishing a plurality of rules for governing the affinity program based at least in part on the received information. In some embodiments, the instructions also include instructions for establishing a communication portal configured to receive at least one expression of interest or user recommendation regarding the affinity program.

In some embodiments, the instructions also include instructions for establishing, by at least one of a plurality of potential participants or current participants, a communication portal configured to interact with the benefactor. In some such embodiments, the communication portal is configured to facilitate negotiation between the at least one potential or current participant and the benefactor.

According to embodiments of the invention, a computer program product has a non-transient computer-readable memory including instructions for creating an affinity program. The instructions include instructions for receiving an expression of interest for a benefactor from a user, proposing creation of an affinity program associated with the benefactor to the user, and creating an affinity program associated with the benefactor. Creating an affinity program includes determining at least one triggering action for triggering a donation to the benefactor, determining at least one potential participant for the affinity program, and inviting the at least one potential participant to join the affinity program.

In some embodiments, the instructions for creating the affinity program also include instructions for proposing the affinity program to the benefactor and negotiating contractual terms with the benefactor on behalf of a program administrator. In some such embodiments, the instructions also include an artificial intelligence engine configured for negotiating the contractual terms on behalf of the program administrator. In some embodiments, the at least one potential participant is or includes the user.

In some embodiments, the benefactor has pre-established a plurality of affinity program creation rules, and the instructions for creating the affinity program also include instructions for determining that a number of expressions of interest from unique users surpasses a predetermined threshold. The instructions also include instructions for, in response to determining the number of expressions of interest from unique users surpasses the predetermined threshold, initiating the affinity program. The instructions for initiating the affinity program includes instructions for initiating an invitation to at least one of the users to join the affinity program. In some such embodiments, the benefactor pre-established the plurality of affinity program rules by negotiating the plurality of affinity program rules with a program administrator.

In some embodiments, a program administrator has pre-established a plurality of affinity program creation rules, and the instructions for creating the affinity program also include instructions for determining that a number of expressions of interest from unique users surpasses a predetermined threshold. The instructions also include instructions for, in response to determining the number of expressions of interest from unique users surpasses the predetermined threshold. The instructions for initiating the affinity program include instructions for initiating an invitation to at least one of the users to join the affinity program. In some such embodiments, the program administrator pre-established the plurality of affinity program rules by negotiating the plurality of affinity program rules with the benefactor.

In some embodiments, the instructions for creating the affinity program also include instructions for determining that a number of expressions of interest from unique users surpasses a predetermined threshold. The instructions also include instructions for proposing the affinity program to the benefactor and negotiating contractual terms with the benefactor on behalf of a program administrator. In some such embodiments, an artificial intelligence engine negotiates the contractual terms.

In some embodiments, the instructions for creating the affinity program also include instructions for receiving information indicating at least one interest of at least one of the potential participants and establishing a plurality of rules for governing the affinity program based at least in part on the received information. In some embodiments, the instructions also include instructions for establishing a communication portal configured to receive at least one expression of interest or user recommendation regarding the affinity program.

In some embodiments, the instructions also include instructions for establishing, by at least one of a plurality of potential participants or current participants, a communication portal configured to interact with the benefactor. In some such embodiments, the communication portal is configured to facilitate negotiation between the at least one potential or current participant and the benefactor.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a flowchart illustrating a method 100 for tracking use of an affinity account owned by a customer and organized in accordance with one or more account rules according to embodiments of the invention;

FIG. 2 is a flowchart illustrating a method 200 including additional steps for tracking use of an affinity account according to embodiments of the invention;

FIG. 3 is a flowchart illustrating a method 300 including additional steps for tracking use of an affinity account according to embodiments of the invention;

FIG. 4 is a flowchart illustrating a method 400 including additional steps for tracking use of an affinity account according to embodiments of the invention;

FIG. 5 is a flowchart illustrating a method 500 including additional steps for tracking use of an affinity account according to embodiments of the invention;

FIG. 6 is a flowchart illustrating a method 600 including additional steps for tracking use of an affinity account according to embodiments of the invention;

FIG. 7 is a diagram of an environment 700 in which the system 701 operates according to embodiments of the invention;

FIG. 8 is a flowchart illustrating a method 800 for creating an affinity program according to embodiments of the invention;

FIG. 9 is a flowchart illustrating a method 900 including additional, alternate sub-steps for creating an affinity program associated with a benefactor according to embodiments of the invention; and

FIG. 10 is a flowchart illustrating a method 1000 including additional, alternate steps and sub-steps for creating an affinity program associated with a benefactor according to embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As discussed above, affinity accounts, in various instances, may refer to banking accounts, such as demand deposit accounts (DDAs) like checking and/or savings accounts or credit or debit accounts associated with a card or other payment device. The accounts may be considered “affinity” accounts due to an association with an affinity such as an organization, business, non-profit, association or other entity or individual for which some benefit may be bestowed if the owner of the account achieves a predefined goal. For example, in some instances, an affinity account is associated with an affinity of the customer such as a non-profit organization, such as a charitable organization.

In some such instances, the affinity account is organized such that a predetermined threshold of spending using the affinity account triggers an automatic donation to the charitable organization. In various examples, the predetermined threshold may be a relatively low amount or a relatively high amount. In some instances, a donation or other benefit is bestowed on the customer's affinity as a result of every transaction, regarding of the transaction amount, and in other instances, a donation or other benefit is bestowed on the customer's affinity as a result of reaching a threshold after several transaction amounts are summed. In some instances, a group of people are associated and work toward a common goal in order that a donation or other benefit is bestowed on the affinity.

Embodiments of the invention provide transparency into the status of the affinity account as well as any accumulating points, rewards, or credits toward a goal associated with a benefit to be bestowed on the affinity. Accordingly, customers may become more incentivized to use the affinity account and potentially open additional affinity accounts to work towards benefits to other affinities. Similarly, groups of like-minded customers may associate with one another, and based on the additional transparency in the affinity programs provided by embodiments of the invention, may decide to focus their group efforts around one or more affinity programs offered by a financial institution. The affinity account arrangement may be beneficial to the affinity, the financial institution and also should satisfy the customer as he or she is providing benefits to a chosen affinity. In that regard, the affinity program is truly a win-win-win situation.

According to embodiments of the invention, a method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, determining that the transaction amount justifies a donation according to the account rules, initiating a donation according to the account rules and tracking the transaction amount and the donation resulting from the use of the affinity account. In some embodiments, tracking includes storing information regarding the transaction including an amount of the transaction and storing information regarding the donation including an amount of the donation. The method also includes communicating some or all the stored information regarding the donation to the customer.

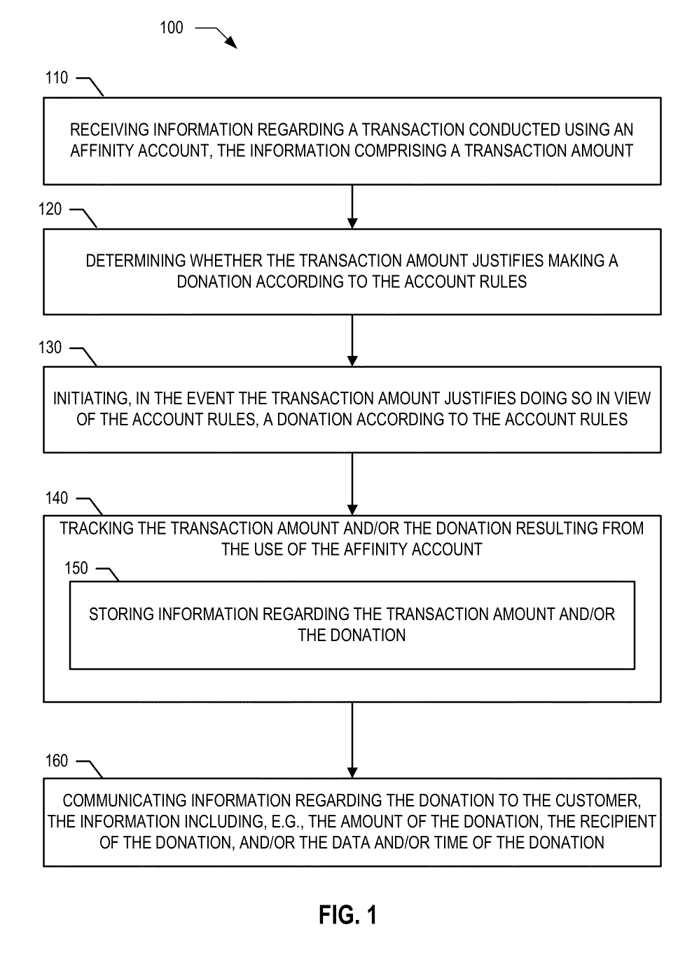

Referring now to FIG. 1, a flowchart illustrates a method 100 for providing a treasury pricing tool according to embodiments of the invention. The first step, as represented by block 110, is receiving information regarding a transaction conducted using an affinity account. In some instances, the information includes a transaction amount. Generally, a customer presents a transaction device to a merchant. The transaction device, as discussed further below, may be a banking card such as a credit or debit card associated with a DDA or some other bank account. The account is associated with an affinity program managed by a financial institution such as a bank. In some instances, the transaction device is branded to indicate an affinity association and a corresponding affinity program managed by the issuer of the transaction device.

As used herein, a “bank account” refers to a credit account, a debit/deposit account, or the like. Although the phrase “bank account” includes the term “bank,” the account need not be maintained by a bank and may, instead, be maintained by other financial institutions. As used herein, unless specifically limited by the context, a “transaction” may refer to a purchase of goods or services, a return of goods or services, a payment transaction, a credit transaction, or other transaction involving the consumer's bank account. As used herein, the term “products” refers to both goods and services.

A “transaction device” as used herein refers to any device used by the consumer to transfer or point to information useful to the vendor during a transaction proximate a point of sale. The term is intended to be read broadly to include many different types of devices such as loyalty devices, mobile devices, payment devices, and any other devices carried by a consumer during a transaction proximate a point of sale. When used herein, the term “payment device” is used synonymously with “transaction device” and is intended to include not only payment devices but also any other type of transaction devices as defined above. Examples of transaction or payment devices as used herein include, but are not limited to, loyalty devices such as loyalty cards or other loyalty devices, magnetic-based payment devices such as credit cards, debit cards, and the like, personal identification number (PIN) payment devices, contactless payment devices such as key fobs, radio frequency identification devices (RFID) and the like, and mobile devices such as smartphones, cellular phones, personal digital assistant (PDA) devices, MP3 devices, personal GPS devices and the like.

The next step, as represented by block 120, is determining whether the transaction amount justifies making a donation according to account rules. The affinity account is associated with an affinity program managed by the financial institution. In some instances, the affinity program has a set of rules by which the affinity program is operated. Such rules correspond to a set of account rules by which the specific affinity account owned by the customer is managed. For example, in one embodiment, the affinity program has a set of rules dictating cumulative purchase thresholds of $XXXX.XX increments in order to warrant a benefit bestowed on the affinity associated with the affinity account. The rules of the affinity program correspond to a set of account rules configured to manage the affinity account. In the example above, the account rules may dictate that a message is communicated by the financial institution server involved in one or more transactions associated with the affinity account to an affinity server also maintained by the financial institution. The message may include information regarding the transaction such as the transaction amount as illustrated by block 110 discussed above. The affinity server or other processing device configured for receiving the information regarding the transaction then determines whether the transaction amount surpasses the predetermined threshold or other criteria dictated by the account rules. In the example above, the customer's previous transaction amounts are summed in addition to the current transaction amount to determine whether the summed amount surpasses the predetermined threshold of $XXXX.XX.

The next step, as represented by block 130, is initiating a donation according to the account rules in the event the transaction amount justifies doing so. As discussed above, the determination is made whether the transaction amount justifies initiating the transaction in step 120. If so, the processing device, such as a financial server or affinity server, initiates a donation or initiates bestowing of some other benefit as dictated by the rules associated with the affinity program. For example, a benefit may be bestowed such as frequent flier miles, cash rewards, rewards points, or some other benefit to the customer's affinity. The customer's affinity, in various embodiments, is a person related to the customer, such as the customer's spouse, parent or child.

In some embodiments, once a donation or other benefit has been bestowed, the next benefit to be bestowed is calculated based on a non-linear scale, for example, a donation is made at $1000.00, another at $1500.00 and another at $1750.00 worth of purchases made using the affinity account. In some embodiments, the donation amount changes based on the product(s) the customer is purchasing with the affinity account, and in some embodiments, the donation amount changes based on the level of transaction amount. For example, for a $1000.00 purchase, a donation of 5% is made, whereas when the transaction amount is $50,000.00, a donation of 3% is made. As another example, in some embodiments, the donation amount is determined not based on percentage of transaction amount but rather as a fixed amount upon the customer's transactions rising above a predetermined threshold. In some embodiments, the donation is made based on the specific goods and/or services being purchased by the customer. In this regard, the financial institution may implement a program in association with the affinity program to entice the customer to purchase one or more specific products by offering different or perceptibly better benefits to the customer's affinity. In some embodiments, financial institution may contract with a product seller in order that that product will be offered greater than usual affinity program benefits, thereby enticing the customer to purchase specific products.

The next step, as represented by block 140 is tracking the transaction amount and/or the donation resulting from the use of the affinity account. In some instances, the transaction amount was determined not to be sufficient to justify making a donation or bestowing some other benefit as discussed above with reference to blocks 120 and 130. In such situations, the transaction amount may be tracked. In some embodiments, step 140 includes a sub-step, as represented by block 150, of storing information regarding the transaction amount and/or information regarding the donation or other bestowed benefit. In circumstances such as the example discussed above, the transaction amount may be stored for retrieval proximate in time to the next transaction involving the affinity account. In this regard, the system can, in view of the stored information regarding the transaction amount, make a determination with regard to whether a new transaction amount justifies making a donation or otherwise bestowing a benefit on the affinity of the customer.

In instances where the transaction amount, either by itself or in combination with one or more other transaction amounts associated with the affinity account of the same customer or other customers participating in an affinity group, justifies initiating a donation, the system stores information regarding the donation, such as the donation amount, the donation recipient, the donation date and/or time.

The last step, as represented by block 160 is communicating information regarding the donation to the customer. In some embodiments, the information includes, for example, the amount of the donation, the recipient of the donation, and/or the data and/or time of the donation. Thus, a level of transparency is provided to the customer so that the customer is aware that the donation occurred when a particular transaction was completed and/or when a particular threshold was surpassed. In some embodiments, the system communicates additional information to the customer such as the status of the accumulation of transaction amounts, which are alternatively stored as points or some other representative item. In this regard, the customer is aware of the accumulation of transaction amounts. In some embodiments, the system also communicates information related to the goals of the customer and/or the customer's affinity group. For example, the system may communicate that the next donation to the customer's affinity occurs when the customer has made $500.00 worth of additional purchases using the affinity account and that the amount of the potential donation is $10.00. As another example, in instances where the customer belongs to an affinity group working towards common goals, the system may communicate messages to the customer individually or to the entire group regarding the status of accumulation toward a goal and information regarding the nature of the benefit to the affinity should the goal be achieved.

In some embodiments, the charity or receiving entity is queried regarding its present needs. A goal may be dynamically created in conjunction with the receiving entity in order to meet the receiving entity's most dire needs. In addition, progress toward the goal may also be communicated to the receiving entity, and in some instances, to the affinity group as well, so that an element of accountability is added. For example, a charity that is the target of an affinity group may be contacted regarding its current needs. The charity may be in need of fifty wheelchairs, and thus communicates that need to the affinity group. As the affinity group works toward reaching the goal, the charity is notified periodically of the progress.

In various embodiments, feedback regarding the nature of the customer's contribution, such as a donation, may be communicated to the customer once the donation has been made and after the donation has been applied by the receiving entity. For example, in one embodiment, the receiving entity is a soup kitchen and the donation is applied to purchase ingredients for soup for feeding impoverished people. Once the donation has been applied by the soup kitchen, the customer is notified of the actual effect of the donation. In various embodiments, communications regarding the nature of the application of the donation are initiated in varying periodic time frames, such as monthly, quarterly, bi-annually, or annually. In various other embodiments, communications regarding the nature of the application of the donation are pushed on demand, such as, proximal in time to the application of the donation by the receiving entity.

In some embodiments, the donation amount is a rider on the transaction itself. For example, in one embodiment, the affinity account is configured such that a predetermined donation amount or percentage is added to the transaction amount for every transaction. In other embodiments, the donation amount is added to the transaction amount only for specific transactions. For example, the donation amount may be added to the transaction amount only for transactions involving a predetermined class of goods and/or services or specific goods and/or services or only goods and/or services purchased from one or more predetermined merchants. In these embodiments, step 120 includes determining whether the nature or character of the transaction justifies making the donation according to the pre-established account rules. In some embodiments, the determination includes determining that every transaction amount justifies making a donation as discussed in the example above. In other embodiments, the determination includes on making a donation when the transaction satisfies the predetermined rules, such as, for example, the transaction being characterized as an electronics purchase.

In these embodiments, step 130 includes initiating the predetermined donation amount in the event the transaction satisfies the account rules. For example, if the transaction is characterized in a fashion commiserate with the account rules, such as an electronics purchase, then, in some embodiments, the donation amount is automatically added to the transaction amount during the transaction itself. In other embodiments, the donation amount is added to the transaction amount at a later time, and in yet other embodiments, the donation amount is not added to the transaction amount but is considered a separate transaction.

In these embodiments, step 140 includes tracking the donation resulting from the use of the affinity account similarly to that discussed above. In some instances, however, the customer may be unaware that a particular class of purchase, for example, resulted in a donation. In such instances, the customer may be informed of this via the communication of step 160.

In some embodiments, the donation amount is drawn from the customer's affinity account funds, and in other embodiments, the donation amount is drawn from one or more of the customer's other accounts with the same financial institution managing the affinity account and/or another financial institution. In some embodiments, the donation amount is drawn from an account other than the customer's account. For example, the donation amount may be drawn from an account owned by the financial institution managing the affinity program.

In some embodiments, the affinity program has been arranged with particular merchants, manufacturers or others within the product chain in order that the price of the product(s) being purchased have been reduced such that the customer utilizing the affinity account does not pay an additional donation amount during the transaction, but rather, the customer pays the same price for the product(s) as any other customer. However, in this example, a portion of the transaction amount is donated to the affinity of the customer's choice. In this regard, the customer is provided an incentive to purchase the product(s) for which there will be a donation, especially considering the lack of increase in price. In some other embodiments, the financial institution may even negotiate a price below market value and also include a donation to the customer's affinity. Embodiments of the invention, among other things, provide the customer vision into the donations actually taking place as well as information regarding the types and quantities of transactions resulting in donations.

In some embodiments, an entity within the chain of distribution for goods, such as a retailer or manufacturer, is making a donation based on user behavior. One or more of those entities within the distribution chain can communicate with the account holder in order to provide vision into the end result of the donation being made. For example, if the retailer donates to a specific local charity, the retailer can send a communication to the user detailing the amount of the donation, and for example, that the donation was used to purchase cleaning supplies for a local charity.

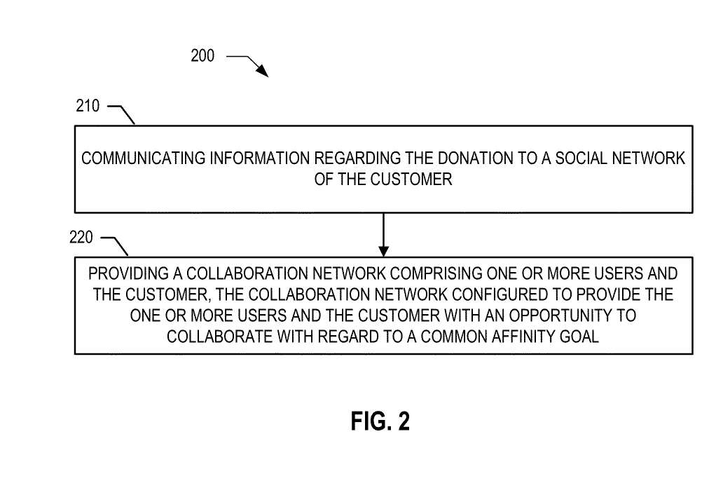

Referring to FIG. 2, a flowchart illustrates a method 200 including various steps, each of which may or may not be included with the one or more of the steps of method 100 illustrated in FIG. 1 according to various embodiments of the invention. The first step, as represented by block 210, is communicating information regarding the donation to a social network of the customer. In various embodiments, the social network may be or include facebook, twitter, myspace, linkedin or some other social network. In some embodiments, the social network includes or is an affinity group or network of people having a common goal.

The next step, as represented by block 220, is providing a collaboration network. In some embodiments, the collaboration network includes one or more users and the customer. The collaboration network, in various embodiments, is configured to provide the one or more users and the customer with an opportunity to collaborate with regard to a common affinity goal. For example, in some instances, a collaboration network may be established by a group of like-minded people interested in raising funds for a specific charitable organization. In this example, the people participating in the group may open affinity account linked together by the financial institution such that the purchases made using the various affinity accounts are summed in order to determine progress toward the common goal. In various embodiments, the collaboration network is configured similar to other social networks such that the participants may communicate with one another through various media such as message boards, blogs, real time chatting, messaging and the like.

In various embodiments, the collaboration network is configured by the participants to include a unique set of collaboration network rules configured for dictating the affinity program management. For example, at what thresholds benefits will be bestowed on the affinity. In some embodiments, the collaboration network rules are based in part on a predetermined set of affinity program rules set forth by the financial institution offering the collaboration network opportunity. For example, the collaboration network may be allowed to set particular thresholds for benefits to be bestowed to the chosen affinity of the collaboration network, however, the amounts or levels of benefits are dictated by predetermined affinity program rules. For example, the network may choose to set a goal at $500.00, and the donation would be dictated by the rules established by the financial institution at $25.00. If the network had chosen $1000.00, however, the donation dictated by the financial institution would be $65.00, which is a better percentage of the overall transaction accumulation amount.

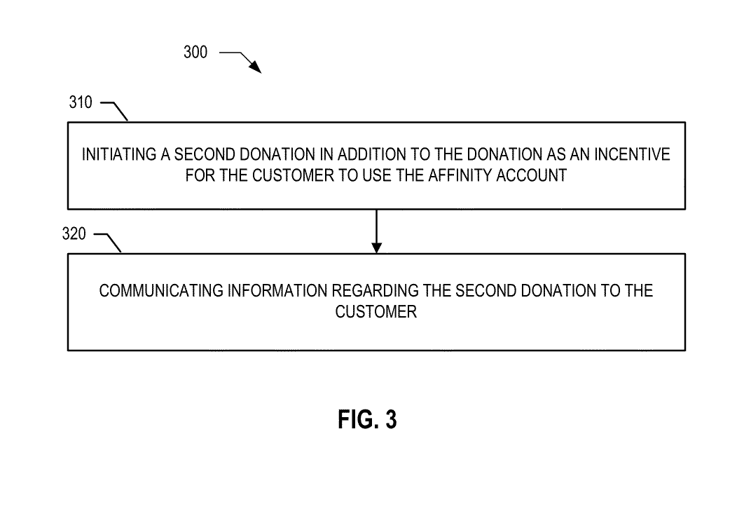

Referring now to FIG. 3, a flowchart illustrates a method 300 including steps, each of which may or may not be included with one or more of the steps of method 100 and/or method 200 illustrated in FIGS. 1 and 2, respectively, according to various embodiments of the invention. The first step, as represented by block 310 is initiating a second donation in addition to the original donation as an incentive for the customer to use the affinity account. As discussed above, in some affinity programs, the customer will achieve multiple goals at different levels of transaction amount. In this regard, the customer is provided an incentive for continuing to use the affinity account even after achieving a goal. In fact, the customer may be further motivated by the fact that a goal was achieved, a donation or other benefit was bestowed, and the system has communicated such information indicating this to the customer.

The next step, as illustrated by block 320, is communicating information regarding the second donation to the customer. Further to the discussion above, information regarding a second donation or other benefit bestowed on the customer's chosen affinity may entice the customer to continue using the affinity account for purchases or other transactions. In various embodiments, every donation or benefit bestowed on the customer's chosen affinity is communicated to the customer so that the customer will be cognizant of he impact the customer's spending behavior is having on the affinity. In some embodiments, the system also receives feedback from the affinity in order to communicate some or all the feedback to the customer so that the customer may have additional incentive to continue using the affinity account for purchases.

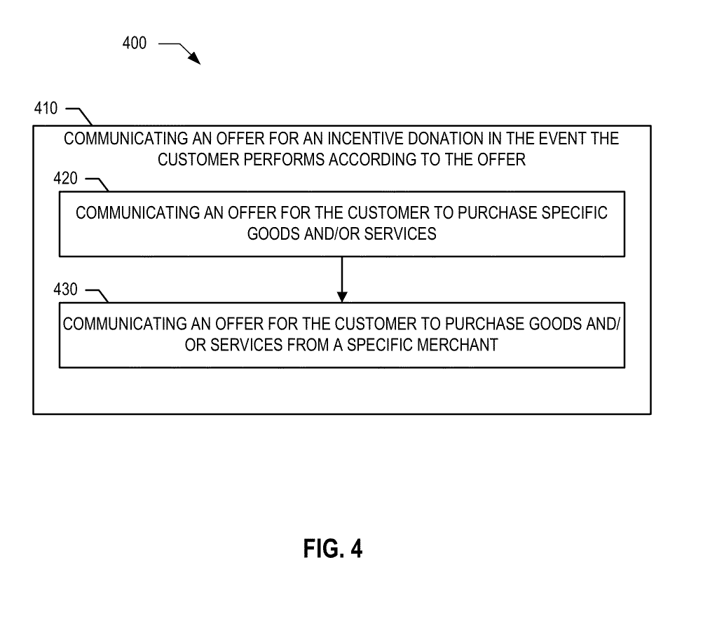

Referring now to FIG. 4, a flowchart illustrates a method 400 including steps, each of which may or may not be included with some or all the steps of method 100, method 200, method 300 and/or other steps according to various embodiments of the invention. As represented by block 410, the first and only step is communicating an offer for an incentive donation in the event the customer performs according to the offer. In various embodiments, step 410 includes one or more sub-steps, such as sub-steps represented by blocks 420 and 430.

In block 420, an offer is communicated for the customer to purchase specific goods and/or services. The offer may be, in various embodiments, an offer to purchase goods and/or services for which the financial institution managing the affinity account has negotiated a kickback payment or some other arrangement that is mutually beneficial to the financial institution and the merchant, manufacturer or other entity in the product chain of the goods and/or services. In some embodiments, the offer may include incentives for the customer to purchase the specific goods and/or services, such as, for example, an added donation or other benefit to be bestowed in the event the customer performs according to the offer and purchases the specific goods and/or services. Similarly, in block 430, an offer is communicated for the customer to purchase goods and/or services from a specific merchant. The financial institution, for example, may have a negotiated arrangement with the merchant that provides some mutual benefits. Likewise, the offer may provide the customer an opportunity for an otherwise unavailable discount and/or an opportunity to achieve an affinity program donation or other benefit for the customer's chosen affinity.

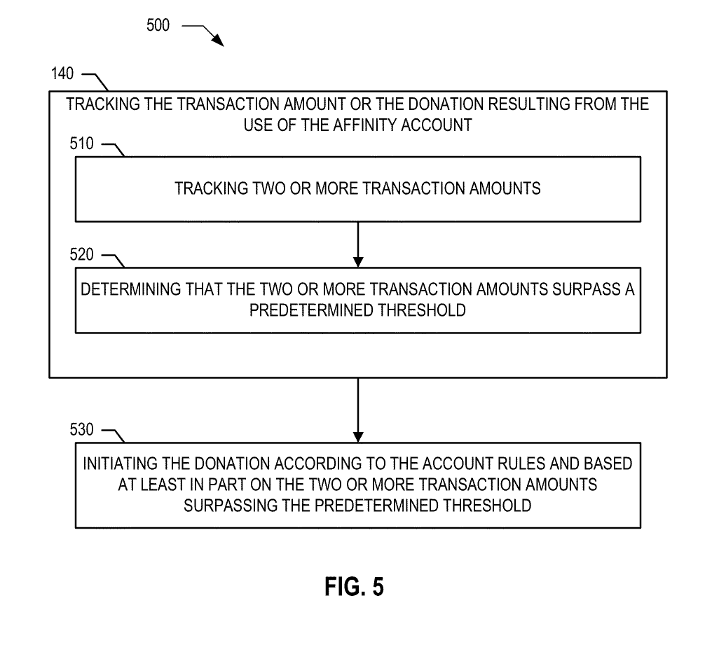

Referring now to FIG. 5, a flowchart illustrates a method 500 including steps, each of which may or may not be included with some or all the steps of the various methods discussed herein and/or other steps according to various embodiments of the invention. The first step, as represented by block 140, and initially presented in FIG. 1, is tracking the transaction amount or the donation resulting from the use of the affinity account. In some embodiments, step 140 includes sub-steps such as those represented by blocks 510 and 520.

As represented by block 510, the first sub-step is tracking two or more transaction amounts. In tracking two or more transaction amounts, the system may determine an accumulated transaction amount and then compare that amount to one or more predetermined thresholds in order to determine whether a donation or other benefit is in order. As represented by block 520, the next sub-step is determining that the two or more transaction amounts surpass a predetermined threshold. The next step in method 500, as represented by block 530, is initiating the donation according to the account rules and based at least in part on the two or more transaction amounts surpassing the predetermined threshold.

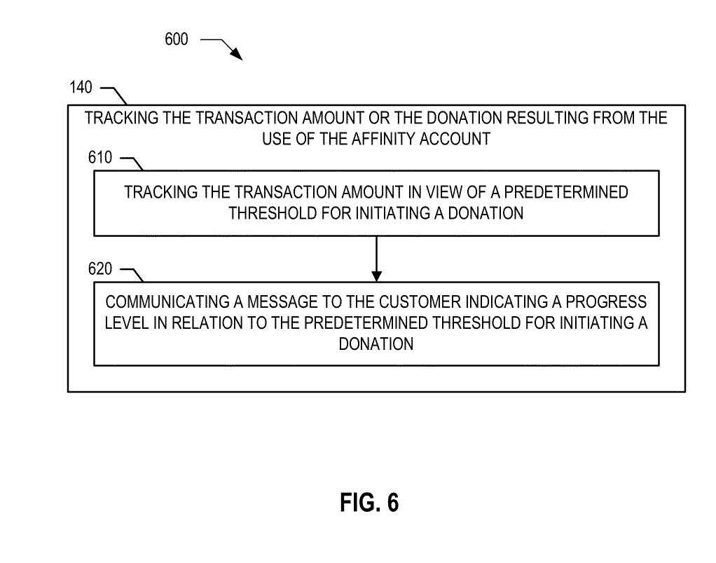

Referring now to FIG. 6, a flowchart illustrates a method 600 including steps, each of which may or may not be included with some or all the steps of the various methods discussed herein and/or others steps according to various embodiments of the invention. The method includes step 140, which was first presented in FIG. 1, where the processing device tracks the transaction amount or the donation resulting from the use of the affinity account. In some embodiments, step 140 includes one or more sub-steps, such as sub-steps represented by blocks 610 and 620. As represented by block 610, the first sub-step is tracking the transaction amount in view of a predetermined threshold for initiating a donation. The system tracks the transaction amount, and in some embodiments adds the transaction amount with one or more previous transaction amounts in order to track an accumulated transaction amount. This amount is compared to a predetermined threshold amount for initiating a donation or other benefit. In some embodiments. As represented by block 620, the next sub-step is communicating a message to the customer indicating a progress level in relation to the predetermined threshold for initiating a donation. Thus, the system communicates to the customer information useful for motivating the customer to continue using the affinity account for purchases. This motivation appeals to social norms as well as a sense of reciprocity, that is, that the customer is working toward a cognizable goal and is aware of the impact of certain actions in view of reaching that goal. Therefore, the customer continues accumulating transaction amounts and thereby achieves the predetermined threshold and the donation or other benefit.

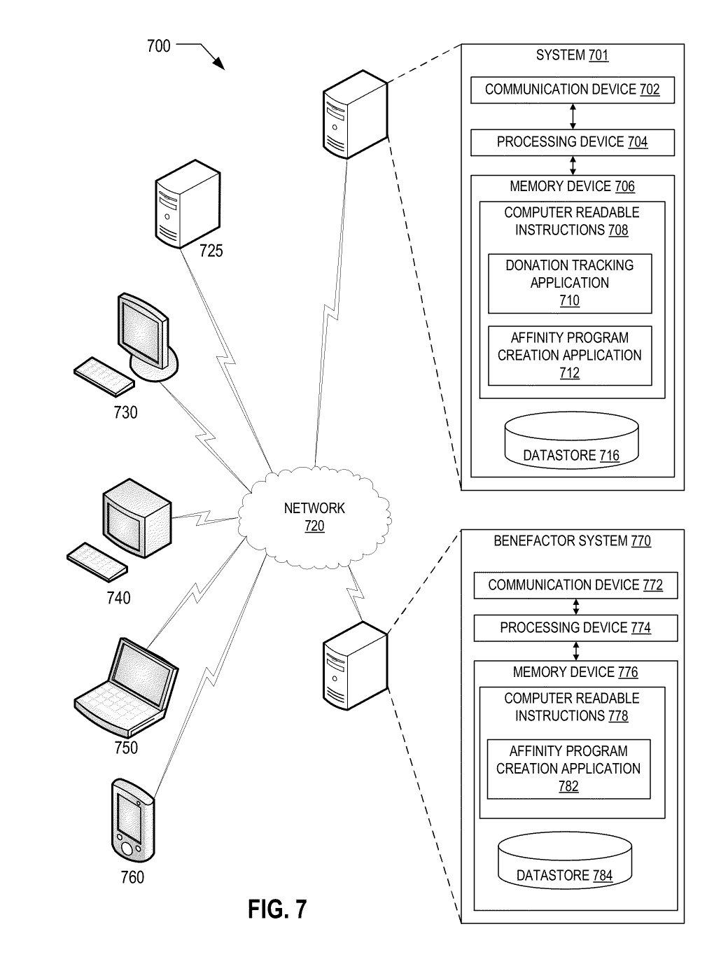

Referring now to FIG. 7, an environment 700 in which a system 701 operates is illustrated. The system 701 may, in various embodiments be configured for performing one or more of the steps discussed with regard to one or more of methods 100, 200, 300, 400, 500, 600, 800, 900, and/or 1000 including or excluding one or more of the various steps disclosed above and/or disclosed below. In the configuration shown, the system 701 communicates across a network 720 with one or more other systems, such as system 725, other servers, remote devices, such as workstation 740, workstation 730, laptop 750 and/or handheld device 760. This configuration is intended to illustrate that a customer or other user (not shown) can interact with the system 701 using a variety of devices remote to the system 701. Furthermore, in some embodiments one or more customers can interact with the system 701 locally such as through an input/output device attached directly with the system 701.

In some embodiments, the system 725 represents one or more financial institution servers configured to communicate across the network with one or more other servers, thereby forming a banking network configured to process transaction such as those discussed herein. The system 725, in some embodiments is also configured for communicating with the system 701, which in various embodiments, may or may not be maintained by the same financial institution that maintains one or more of the servers and/or other systems represented by system 725. In some embodiments, the system 725 is or includes the system 701, and in some embodiments the system 701 is or includes the system 725. In some embodiments, the system 725, representing one or more components or systems of the financial institution and transaction network, communicates information regarding one or more transactions and/or one or more donations or benefits associated with the one or more transactions to the system 701. The system 701, as indicated in step 110 of FIG. 1, receives the information from the system 725. In some embodiments, the system 725 communicates information to the system 701 and awaits instructions regarding whether to proceed with a donation and/or bestow other benefit(s). In some such embodiments, the system 701 makes a determination regarding the donation or other benefit and then communicates the decision across the network 720 to the system 725. The system 725, in some embodiments, immediately initiates the donation during or immediately after the transaction has closed. In some embodiments where the system 725 is or include the system 701, the communication occurs internally to the system 725 or 701. In some embodiments the customer interacts with the system 725 directly without requiring the network 720. For example, the customer presents a transaction device such as a payment device at a point of sale owned by a merchant. The customer initiates payment for a purchase using the point of sale and through the payment device. The merchant point of sale, which is either part of the system 725 or is connected with the system 725 across the network 720 then communicates with the system 701 information regarding the transaction. In various embodiments, the transaction device associated with the affinity account, such as a bank card or smart card, includes data presenting instructions for the point of sale to communicate with the system 701 in order to determine whether a donation is appropriate. In some embodiments, the transaction device, such as, for example, a mobile device 760, includes data presenting instructions for the point of sale to initiate a donation based on rules also included in the data stored by the transaction device.

The system 701, in various embodiments, has a communication device 702 controlled by a processing device 704 configured to communicate across the network 720. The network 720 is an intranet, the Internet, a local area network, a wide area network, and/or any other electronic device network, and/or any combination of the same. The processing device 704 is also in communication with a memory device 706 configured for storing computer-readable instructions 708, which are also computer-executable. The computer-readable instructions, in various embodiments, include one or more applications, such as a donation tracking application 710.

Generally, in some embodiments, some, all or none of the method steps and/or sub-steps discussed above with reference to FIGS. 1, 2, 3, 4, 5, 6, 8, 9 and/or 10 are embodied in computer-executable instructions within the donation tracking application 710. In some embodiments, one or more applications are contained within one application, and in other embodiments, the instructions for executing the donation tracking application are spread over two or more applications. In some embodiments, some of the instructions for executing the donation tracking application are stored on the system 701 and some of the instructions are stored on a customer device, such as a transaction device, other mobile device or workstation or server. In some embodiments, some or all the instructions are stored remotely from the system 701 and accessed as necessary by the donation tracking system 701 and/or any other device requiring instructions. Further, in some embodiments, the memory device 706 includes a datastore 716 configured for storing instructions, information and/or data such as the account rules configured for managing the accounts associated with affinity programs. In some embodiments, the datastore 716 is also configured for storing information and/or data such as one or more tables including entries associated with a plurality of affinity programs and their associated affinity rules or other instructions or data associated with the various programs. In other embodiments, the datastore 716 is housed remotely from the system 701 and the system 701 is in communication with the datastore 716 across the network 720 and/or across some other communication link.

In some embodiments one or more additional systems or servers are configured for communicating with the system 701. In some such embodiments, information regarding different customers may be stored in various locations on different systems. In some embodiments, information regarding one customer's financial accounts, affinity accounts, and/or group affinity accounts may be stored on separate systems or datastores. In some embodiments, a system 701 functions as a central control server and accesses the various pieces of information, data and/or instructions from various locations, thereafter presenting it to the customer and/or performing the processes associated with the instructions using a processing device and/or other system components shown in FIG. 7 or otherwise. In various other embodiments, multiple servers or systems functions together as a central control server and access different pieces of data and/or instructions in order to perform one or more of the steps discussed above.

In summary, a method for tracking use of an affinity account owned by a customer and organized in accordance with one or more account rules includes receiving information regarding a transaction conducted using an affinity account, the information comprising a transaction amount, determining, using a processing device, whether the transaction amount justifies making a donation according to the account rules, determining that the transaction amount justifies a donation according to the account rules, initiating a donation according to the account rules and tracking the transaction amount and the donation resulting from the use of the affinity account. In some embodiments, tracking includes storing information regarding the transaction including an amount of the transaction and storing information regarding the donation including an amount of the donation. The method also includes communicating some or all the stored information regarding the donation to the customer.

According to other embodiments of the invention, systems, apparatuses, methods, and computer program products are configured to create an affinity program. Embodiments of the invention receive an expression of interest for a benefactor from a user, propose creation of an affinity program associated with the benefactor to the user, and create an affinity program associated with the benefactor. Creating includes determining at least one triggering action for triggering a donation to the benefactor, determining at least one potential participant for the affinity program, and inviting the at least one potential participant to join the affinity program. In some embodiments, creating the affinity also includes proposing the affinity program to the benefactor and negotiating contractual terms with the benefactor on behalf of a program administrator, such as, by using an artificial intelligence engine. In some embodiments, creating the affinity also includes, in response to determining the number of expressions of interest from unique users surpasses a predetermined threshold, initiating the affinity program by inviting at least one of the unique users to join the program. In some embodiments, the invention establishes a plurality of rules for governing the affinity program based on information received from potential participants, and in some embodiments, a communication portal is configured to receive at least one expression of interest or user recommendation regarding the affinity program, for example, that may be useful to the system in negotiating contractual terms of the affinity program with the benefactor. The communication portal may also be used to communicate with the benefactor, such as, facilitating contractual negotiation communications between the program administrator and the benefactor.

In some instances, a collaboration network among similarly minded individuals or entities may be established. This collaboration network may formed by a group of individuals dynamically coming together to form an affinity where the terms and conditions of the affinity are negotiated in real-time by intelligent agents or artificial intelligence agents. For example, a customer and his friends want to start an affinity to support a target organization or benefactor, such as an affinity designed to support a well-known charity. Once a predetermined threshold of users indicate a desire to participate in the affinity, such as through a social media network and, in some instances, commit their account to such an effort, the issuer or program administrator engages the target organization to work on terms and conditions of the arrangement. The terms and conditions can be a template and then may be customized. In some embodiments, once the participants agree upon the terms and conditions, an automated application takes over in order to complete the affinity creation and implementation.

In various instances herein, a current affinity program is discussed. One or more of the method steps or sub-steps disclosed may be applied to a current program such that the current program is modified from its current state or confirmed in its current state. Thus, references to “creating” an affinity program may be understood to include, in appropriate circumstances, both creating a previously non-existent affinity program, modifying a pre-existing affinity program, or confirming the current state of a pre-existing affinity program. Furthermore, both potential participants and current participants are discussed. Potential participants may also refer to current participants in one affinity program who may be potential participants of another affinity program or may refer to current participants in an affinity program who are potential participants of a modified version of the affinity program. Current participants may refer to participants of a pre-existing affinity program that may or may not be a candidate for modification or confirmation in its current state.

Referring back to FIG. 7, the computer readable instructions 708 of the system 101 may include an affinity program creation application 712, which is also referred to herein as the application 712. Computer readable instructions 708 may also store the donation tracking application 710 or may not store the donation tracking application 710 in various embodiments. Thus, the system 701 may be focused exclusively or primarily on affinity program creation rather than donation tracking or other purposes or may be focused on affinity program creation in addition to other purposes. In various embodiments, the system 701 may be maintained and/or owned or otherwise associated with one or more users, such as potential participants or current participants in a future or current affinity program. These users may be individuals, groups of individuals, entities or groups of entities. One or more of the users may be a program administrator of the future or current affinity program.

In some embodiments, the system 101 is associated with a financial institution that acts as program administrator for a future or current affinity program, and various users communicate with one another using one or more devices, such as by using devices 725, 730, 740, 750, and/or 760. The users may also communicate with system 701 such as by using a communication portal established by the program administrator. Such a communication portal may be hosted on a server such as server 701 and may be part of application 712 or another application. The program administrator may negotiate with a benefactor of the future or current affinity program in order to determine contractual terms and conditions upon which the program may be based. This negotiation may be conducted by the application 712, such as by an artificial intelligence engine running in application 712. In other embodiments, the artificial intelligence engine is separate from application 712, and in some embodiments, the artificial intelligence engine spans across multiple systems, servers or other devices.

In some embodiments, the application 712 is also stored on other devices, such as device 725 or device 730. Such devices may store a variation of application 712 configured to be used by a user such as a potential participant to the program or a current participant to the program. In some embodiments, the application 712 is identical in the system 701 and the user devices, such as device 725.

Benefactor system 770 may, in various embodiments, be configured for performing one or more of the steps discussed with regard to one or more of methods 100, 200, 300, 400, 500, 600, 800, 900 and/or 1000 including or excluding one or more of the various steps disclosed above and/or below. In the configuration shown, the system 770 communicates across a network 720 with one or more other systems, such as system 701, other servers, remote devices, such as workstation 740, workstation 730, laptop 750, server 725 and/or handheld device 760. This configuration is intended to illustrate that a customer or other user (not shown) can interact with the system 770 using a variety of devices remote to the system 770. Furthermore, in some embodiments one or more users can interact with the system 701 locally such as through an input/output device attached directly with the system 770.

The system 770, in various embodiments, has a communication device 772 controlled by a processing device 774 configured to communicate across the network 720. The network 720 is an intranet, the Internet, a local area network, a wide area network, and/or any other electronic device network, and/or any combination of the same. The processing device 774 is also in communication with a memory device 776 configured for storing computer-readable instructions 778, which are also computer-executable. The computer-readable instructions, in various embodiments, include one or more applications, such as the donation tracking application 710 and/or the affinity program creation application 712.

In one embodiment, for example, a financial institution receives a number of expressions of interest from users, such as customers of the financial institution. The financial institution is associated with system 701, which, based on a predetermined set of rules for establishing affinity programs for the financial institution, initiates communication with the benefactor system 770 in order to begin creation of an affinity program. In some embodiments, this process is mostly automated, for example, the benefactor may have stored a predetermined set of rules for creating an affinity program in benefactor system 770. Thus, when system 701 contacts benefactor system 770, the two systems may automatically create an affinity program that will be administered by the financial institution for the benefit of the benefactor by associating or enrolling the financial institution's customers who have expressed interest in the affinity program.

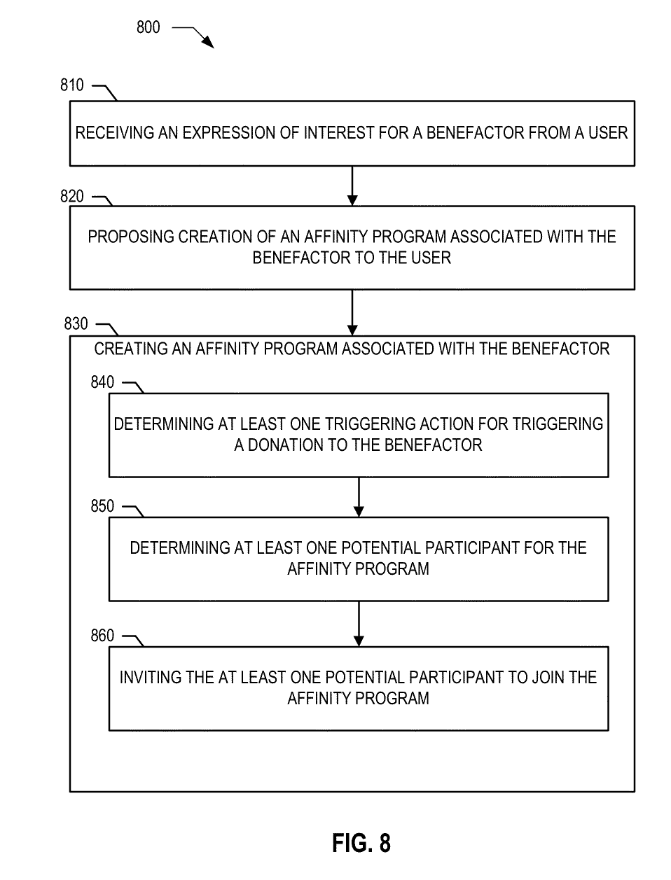

Referring now to FIG. 8, a flowchart illustrates a method 800 for creating an affinity program. At block 810, one or more expressions of interest for a benefactor are received from a user. The expressions of interest typically indicate potential interest in one or more entities, institutions or other object of interest that may or may not be affiliated or associated with a financial institution. An expression of interest may be generated by a user in a variety of ways, through online and/or offline channels. A user's expression of interest may be positive or negative and may fall somewhere on a spectrum of user interest from strongly opposed to the affinity, moving through indifferent to the affinity, to strongly interested in the affinity. Also as discussed further below, a user may generate multiple expressions of interest that are determined to be related to one another and/or that may be determined to both/all be related to one or more affinities.

The user may be logged onto an online banking (OLB) website and may perform some action or inaction, which may be captured and used as an expression of interest in one or more affinities. The financial institution, because the user is logged into the OLB website, knows the identity of the user and can capture and associate user-generated expressions of interest with the user. For example, the user may select an advertisement or link regarding one or more affinities of the financial institution. Similarly, the user may explicitly submit information indicating the user is interested in a particular affinity. For example, the financial institution may provide a user interface for accepting suggestions for a benefactor for a future affinity program. Other examples of OLB expressions of interest may include a user's response to a “splash-off” advertisement or informational message that appears to the user as the user is logging off from the OLB website or leaving a specific page or pages of the OLB website, a user's response to one or more advertisements or informational messages targeted to the user while the user is logged on to the OLB website, a user's input beginning from the homepage of the financial institution website, such as where the user navigates from the homepage, input received from the user on one or more product or informational pages, input received from the user on one or more application pages, and/or the like.

A user may also generate an expression of interest by searching inputs and responses to search results. For example, the user may perform a keyword search on the OLB website. As a more specific example, a user may search for “affinity”, “benefactor”, “charity”, “donation”, or the like, which may be an expression of interest for one or more affinities, existing affinity programs and/or future affinity programs of the financial institution. As another example, a user may perform a search for “close affinity accout” or the like, thereby indicating an expression of interest, although the expression is negative. This expression of interest may be used, rather than to target a customer for an affinity program, as an indicator that the customer may be about to close an account associated with an affinity program. Therefore, efforts can be taken to retain the user as a customer of the affinity program product. As another example, the user may perform a natural search through an external search engine, thereby entering the financial institution's website and/or OLB website. As a specific example, a user may search for “Financial institution affinity program” using a search engine external to the financial institution website, and once the user navigates to the financial institution website, that expression of interest may be captured.

As another example, a user may generate an expression of interest by responding to one or more mobile marketing tools, such as advertisements or informational messages sent via text message, email, or the like. The user's response may include replying to a message or may include selecting a link referred to in the message or otherwise.

Another example of generating an expression of interest is an aged referral. An aged referral refers to a situation where, for example, a customer expresses an interest in an affinity program product, such as to a teller, but does not have time during their visit to discuss the product in detail. The teller may submit a referral to the financial institution system such that the user is referred to a personal banker or other associate of the financial institution. In some instances, the referral is not perfected by the associated and becomes “aged.” The financial institution system may access such information in determining an expression of interest as an input to the methods described herein.

As another example, a user may generate an expression of interest by responding to a teaser message during a call waiting experience, such as while waiting for a customer service representative during a phone call to a customer service center. Such response may include inputting numbers in a touch tone phone, may include voice input that may be recognized using voice recognition techniques, or may be some other type of response/input. This information may be stored by the financial institution systems and used as an input to the methods described herein.

As another example, a user may generate an expression of interest by responding to an automated teller machine (ATM) advertisement. Such an advertisement may be presented by the ATM to the user during a user transaction at the ATM machine, such as when the user is depositing funds using the ATM. For example, the ATM may present the user with a demand deposit account (DDA) product associated with an affinity program that would provide the user an opportunity to make automatic donations to a charity. The user may respond to this advertisement, and that response may be captured as an expression of interest.

Another example of a user expressing interest is during a chat or chatting session. The chat session may be incorporated into the user's online banking experience, such as a customer service representative of the financial institution chatting with the user to answer the user's question(s) regarding an affinity program product offered by the financial institution. Another example of a chatting session is a chat over a website or other media not maintained by the financial institution, such as a public chat or message board. Another example of a user expressing interest is by using a social media application to express interest in an affinity.

The next step, represented by block 820, is proposing creating of an affinity program associated with the benefactor to the user. As discussed above, some of the expressions of interest received from a customer already include a proposal to the customer for a future affinity program product. In other instances, the expression of interest may be less developed, such as an expression of interest by a user that the user likes Charity One. This expression of interest may be captured by the financial institution, and in one embodiment, once enough users express an interest in Charity One, the financial institution may automatically create an affinity program or associates of the financial institution may initiate creation of the affinity program.

The next step, represented by block 830, is creating an affinity program associated with the benefactor for which the user has expressed an interest. The creation of the affinity may be performed automatically, such as, based on a predetermined set of rules store in one or more systems maintained by a financial institution, or may be negotiated with a benefactor and/or potential participants of the affinity program without the benefit of predetermined rules. Such predetermined rules may be related to contractual terms and/or conditions that the financial institution may require in order to establish an affinity program. In other embodiments, the financial institution may predetermine rules dictating amount of donations given transaction amounts or other details regarding the affinity program. As another example, a financial institution may predetermine a matching amount, such as a matching amount associated with particular classes of affinities. For example, for affinities that are non-profit organizations, the financial institution may predetermine rules for establishing an affinity program differently than if the affinity is a for-profit organization.

In some embodiments, the affinity program is an affinity micro-program that is created for a small group of people, such as a family or group of friends in order to benefit a local charity, family, family member, individual, entity or otherwise. In one example, the financial institution may have a predetermined set of rules dictating affinity program creation for micro-programs. One example may be that the financial institution will match a donation to the affinity if the affinity is a charity or needy person(s), whereas the financial institution may not match a donation if the affinity is a family member of the participants in the affinity micro-group. In some such embodiments, the affinity program may be a private program created with rules dictating that only certain individuals or entities may participate.

In some embodiments, creating an affinity program includes determining at least one triggering action for triggering a donation to the benefactor, as represented by block 840. This step refers to establishing some of the rules and/or contractual conditions that will dictate how the affinity group works. For example, a triggering action may be a transaction performed by a participant using an account associated with the affinity program. Another example may be a user entering a financial institution location or logging onto the financial institution website. Other examples of triggering events may be making a number of transactions totaling a predetermined amount or making one or more transactions at a specific merchant or class of merchants.

Creating an affinity program includes determining at least one potential participant for the affinity program as represented by block 850. A potential participant may be one or more users who have expressed interest in the affinity and/or the affinity program. Other examples of potential participants are customers who are known to be in the market for a new account or otherwise have expressed interest in a financial institution product that may or may not already be or may potentially be associated with a current or future affinity program. Potential participants may also be identified based on whether a customer of the financial institution already has an affinity program associated with one or more of his or her accounts. For example, if the customer already has an affinity program associated with a credit account, the customer may be more likely to accept an invitation to be a participant in another affinity program. Also, if a customer does not currently have any affinity program affiliations, but has expressed interest in one or more affinities, the customer may be more likely to accept an invitation to participate in an affinity program.

The last step, represented by block 860, is inviting the potential participant to join the affinity program. This may be done using any type of communication, electronic or non-electronic. For example, SMS messaging, email messaging, hard copy mail, or any other method of communication may be used to invite a potential participant. The potential participant may then enroll electronically, such as by responding to an email or selecting a link within an email or responding to an SMS message. In other embodiments, the customer may be called by a customer service representative and invited to enroll, and the customer may then be enrolled by the customer service representative while on the phone call.

Once the potential participant(s) have been enrolled in the program, the financial institution may issue any cards or other instruments necessary to participate in the triggering action(s). Another example may be a checkbook or other payment or transaction device. In some embodiments, the user's mobile device functions as a point of transaction device that communicates with a point of sale of a merchant. In some such instances, the user may download and install an affinity application in the user's device that facilitates the affinity program, such as by communicating with one or more servers that maintain the affinity program. As another example, the mobile device application may capture information regarding a financial transaction and forward that information to the appropriate server for processing for the affinity program. In another example, the point of sale of the merchant communicates financial transaction information to the financial institution and the financial institution gathers what data or information it needs to carry out the affinity program from the information communicated from the point of sale of the merchant.

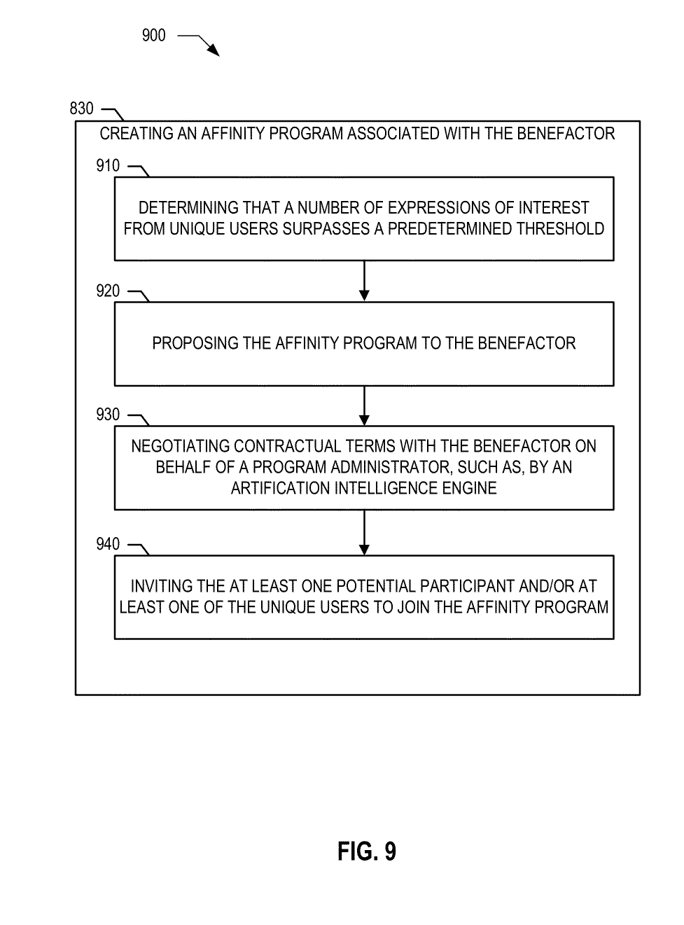

Referring now to FIG. 9, a flowchart illustrates a method 900 including additional, alternate sub-steps for creating an affinity program associated with a benefactor according to embodiments of the invention. Creating an affinity program may include determining that a number of expressions of interest from unique users surpasses a predetermined threshold as represented by block 910. In this regard, the administering entity may wait until sufficient demand for the affinity program is present before moving forward with creation of the affinity program. Also, creating an affinity program may include proposing the affinity program to the benefactor, as represented by block 920, which may be done in response to the number of unique users expressing interest surpassing the predetermined threshold. This communication may be automated or may be performed by an associate of the administering entity.

Further, creating an affinity program may include negotiating contractual terms with the benefactor on behalf of a program administrator, as represented by block 930. Negotiating contractual terms with the benefactor may be performed by an artificial intelligence engine that is part of or is application 712. In some embodiments, once the threshold has been surpassed, an artificial intelligence engine proposes the affinity program to the benefactor, and in some embodiments, the benefactor's system, for example, system 770 also has an application 712 that may include an artificial intelligence engine such that the administering entity's system 701 may interact with the benefactor's system 770 in order to automatically create the affinity program, such as based on a predetermined set of rules established by both the administering entity and the benefactor. In some embodiments, the artificial intelligence engines must escalate the affinity program for approval or in some instances, the artificial intelligence engines must escalate particular aspects of the affinity program for approval before proceeding with the program or the program creation, respectively.

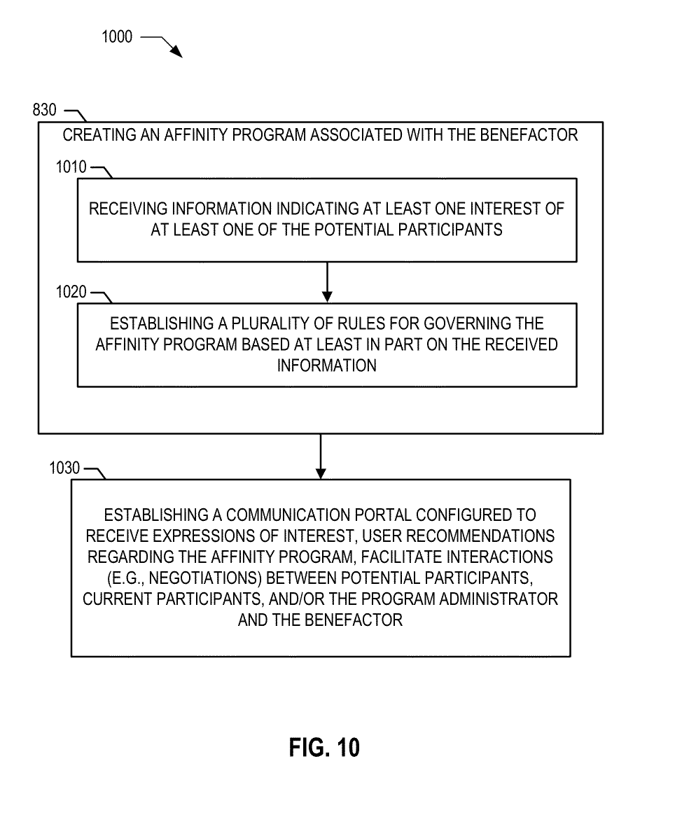

Referring now to FIG. 10, a flowchart illustrates a method 1000 including additional, alternate steps and sub-steps for creating an affinity program associated with a benefactor according to embodiments of the invention. Creating an affinity program may include receiving information indicating at least one interest of at least one of the potential participants, or in some embodiments, current participants, as represented by block 1010. For example, a potential participant or current participant in the affinity program may indicate an interest in a specific financial institution product. In this regard, the affinity program may be tailored to accommodate the specific financial institution product, or, once a number of participants surpasses a predetermined threshold indicating an interest in a particular financial institution product, a new affinity program may be created and associated with the indicated financial institution product. Alternatively, a pre-existing affinity program may be modified to be associated with the indicated financial institution product, which may replace a previously associated financial institution product or may be associated in addition to a previously associated financial institution product.

Also, creating an affinity program may include establishing a plurality of rules for governing the affinity program based at least in part on the received information from the potential and/or current participants, as represented by block 1020. As discussed above, the interest of participants may be capture and used to formulate one or more rules governing creation, modification or confirmation of an affinity program.

The method 1000 may also include establishing a communication portal configured to receive expressions of interest, user recommendations regarding a future or current affinity program, facilitate interactions (e.g., negotiations) among potential participants, current participants, and/or the program administrator and the benefactor, as represented by block 1030. For example, the communication portal may be or include a user interface such as a message board, chat room or otherwise. Various pieces of information may be exchanged between the benefactor and the other interested entities as well as capture and used by one or more of the systems discussed herein to perform one or more of the method steps discussed herein. For example, a user of the communication portal may provide an expression of interest in an affinity, and a financial institution hosting the communication portion may capture that information and use it to create an affinity program as discussed herein. In other embodiments, for example, the benefactor may host the communication portal in order to receive users' expressions of interest. Once a number of interested users has been reached, the benefactor, for example, may create the affinity with a pre-established financial institution and pre-established rules. Thus, the affinity program may be created very quickly in some instances once the required number of participants has been reached.

In some embodiments, in order for a user to indicate that they are interested in an affinity program, the user must perform some action before the affinity program is created, such as, for example, making a deposit that will be credited to the user's account once the affinity program has been created and the user has been enrolled. This allows the administering entity, such as the benefactor or the financial institution or otherwise to ensure the user is serious about participation before spending resources to establish an affinity program.

In some embodiments, the affinity program is created such that the user or users that expressed interest in the affinity program and subsequently become participants maintain and/or market the affinity program to additional users. In this regard, the financial institution or other administering entity may free resources. In some such embodiments, the user or users who expressed interest actually maintain a communication portal in order to market the future affinity program or otherwise to garner support for the affinity.

In various embodiments crowd sourcing is used to determine affinities to associate with one or more affinity programs. For example, the users express interest in a variety of things, and the artificial intelligence engine, either maintained by the financial institution, benefactor or otherwise, recognizes the highest level of interest for a potential affinity based on the crowd sourcing information.

In various embodiments, the benefactor or affinity may not be involved in the negotiation process for the terms and/or conditions that govern the affinity program. For example, in some instances, a group of interested individuals proposed an affinity program to a financial institution and the financial institution negotiates with the group of interested individuals. Once the affinity program is established, the program may simply donate funds or otherwise provide a benefit to the benefactor or affinity unilaterally of the benefactor's prior input.

In various embodiments, a potential affinity or potential benefactor is not an actual organization or entity at the time the user(s) express interest. In some embodiments, the users may create and affinity program, that may be affiliated with a financial institution, but the entity which the affinity program will benefit does not yet exist. For example, the future entity may be a planned entity or may be a prospective or expected entity. A specific example may be that the group expects a non-profit company to be organized within the next year. The financial institution may be willing to create an affinity program that will benefit the non-profit organization once it has been organized.

In various embodiments, the benefactor sets up predetermined rules for governing the creation of the affinity program, and the artificial intelligence engine may create the affinity program automatically. For example, the benefactor may have a predetermined set of rules and/or contract terms that have been pre-negotiated with a financial institution such that once some necessary event(s) have occurred, the affinity program is created. A necessary event may be the number of interested individuals rises above a predetermined threshold or a number of individuals providing a deposit to start the affinity program rises above a predetermined threshold. Similarly, a necessary event may be tied to an amount of donation funds that are received in support of the affinity program before the program is created.

In summary, according to embodiments of the invention, systems, apparatuses, methods, and computer program products are configured to create an affinity program. Embodiments of the invention receive an expression of interest for a benefactor from a user, propose creation of an affinity program associated with the benefactor to the user, and create an affinity program associated with the benefactor. Creating includes determining at least one triggering action for triggering a donation to the benefactor, determining at least one potential participant for the affinity program, and inviting the at least one potential participant to join the affinity program. In some embodiments, creating the affinity also includes proposing the affinity program to the benefactor and negotiating contractual terms with the benefactor on behalf of a program administrator, such as, by using an artificial intelligence engine. In some embodiments, creating the affinity also includes, in response to determining the number of expressions of interest from unique users surpasses a predetermined threshold, initiating the affinity program by inviting at least one of the unique users to join the program. In some embodiments, the invention establishes a plurality of rules for governing the affinity program based on information received from potential participants, and in some embodiments, a communication portal is configured to receive at least one expression of interest or user recommendation regarding the affinity program, for example, that may be useful to the system in negotiating contractual terms of the affinity program with the benefactor. The communication portal may also be used to communicate with the benefactor, such as, facilitating contractual negotiation communications between the program administrator and the benefactor.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for creating an affinity program, the method comprising:
receiving an expression of interest for a benefactor from a customer;
proposing, by a processing device, creation of an affinity program associated with the benefactor to the customer; and
creating, by a processing device, an affinity program associated with the benefactor, the creating comprising:
determining at least one triggering action for triggering a donation to the benefactor;
determining at least one potential participant for the affinity program;
inviting the at least one potential participant to join the affinity program; and
enrolling the at least one potential participant in the affinity program;
providing a collaboration network comprising one or more users and the customer, the collaboration network configured to provide the one or more users and the customer with an opportunity to collaborate with regard to a common monetary collection goal;
linking a plurality of collaboration affinity accounts including the affinity account owned by the customer and one or more affinity accounts owned by the one or more users such that transactions associated with the collaboration affinity accounts are summed to determine progress toward the common monetary collection goal;
receiving the donation from the at least one potential participant and applying the donation to an account associated with the benefactor;
in response to applying the donation to the account associated with the benefactor, initiating communication of information regarding the donation and information regarding progress toward the common monetary collection goal comprising a total amount of donations collected in progress toward the common monetary collection goal to the customer;
in response to applying the donation to the account associated with the benefactor, initiating communication of information regarding the donation and information regarding progress and information regarding progress toward the common monetary collection goal comprising a total amount of donations collected in progress toward the common monetary collection goal to at least one of the users of the collaboration network; and
determining the common monetary collection goal has been achieved by donations made by the collaboration network;
receiving feedback from the benefactor including information indicating an actual effect of the benefactor receiving the donations made by the collaboration network; and
in response to receiving the feedback, initiating communication to the customer and to at least one of the users of the collaboration network, at least some of the information indicating the actual effect to the benefactor of the donations made by the collaboration network.

2. The method of claim 1, wherein creating the affinity program further comprises:
proposing the affinity program to the benefactor; and
negotiating contractual terms with the benefactor on behalf of a program administrator.

3. The method of claim 2, wherein an artificial intelligence engine negotiates the contractual terms on behalf of the program administrator.

4. The method of claim 1, wherein the at least one potential participant is or includes the user.

5. The method of claim 1, wherein the benefactor has pre-established a plurality of affinity program creation rules; and
wherein creating the affinity program further comprises:
determining that a number of expressions of interest from unique users surpasses a predetermined threshold; wherein the method further comprises:
in response to determining the number of expressions of interest from unique users surpasses the predetermined threshold, initiating the affinity program comprising:
initiating an invitation to at least one of the users to join the affinity program.

6. The method of claim 5, wherein the benefactor pre-established the plurality of affinity program rules by negotiating the plurality of affinity program rules with a program administrator.

7. The method of claim 1, wherein a program administrator has pre-established a plurality of affinity program creation rules; and
wherein creating the affinity program further comprises:
determining that a number of expressions of interest from unique users surpasses a predetermined threshold; wherein the method further comprises:
in response to determining the number of expressions of interest from unique users surpasses the predetermined threshold, initiating the affinity program comprising:
initiating an invitation to at least one of the users to join the affinity program.

8. The method of claim 7, wherein the program administrator pre-established the plurality of affinity program rules by negotiating the plurality of affinity program rules with the benefactor.

9. The method of claim 1, wherein creating the affinity program further comprises:
determining that a number of expressions of interest from unique users surpasses a predetermined threshold; and wherein the method further comprises:
proposing the affinity program to the benefactor; and
negotiating contractual terms with the benefactor on behalf of a program administrator.

10. The method of claim 9, wherein an artificial intelligence engine negotiates the contractual terms.

11. The method of claim 1, wherein creating the affinity program further comprises:
receiving information indicating at least one interest of at least one of the potential participants; and
establishing a plurality of rules for governing the affinity program based at least in part on the received information.

12. The method of claim 1, further comprising:
establishing a communication portal configured to receive at least one expression of interest or user recommendation regarding the affinity program.

13. The method of claim 1, further comprising:
establishing, by at least one of a plurality of potential participants or current participants, a communication portal configured to interact with the benefactor.

14. The method of claim 13, wherein the communication portal is configured to facilitate negotiation between the at least one potential or current participant and the benefactor.

15. A system for creating an affinity program, the system comprising a processing device and a memory configured to store instructions for execution by the processing device, the instructions comprising instructions for:
receiving an expression of interest for a benefactor from a customer;
proposing creation of an affinity program associated with the benefactor to the customer;
creating an affinity program associated with the benefactor, the creating comprising:
determining at least one triggering action for triggering a donation to the benefactor;
determining at least one potential participant for the affinity program;
inviting the at least one potential participant to join the affinity program; and
enrolling the at least one potential participant in the affinity program;
providing a collaboration network comprising one or more users and the customer, the collaboration network configured to provide the one or more users and the customer with an opportunity to collaborate with regard to a common monetary collection goal;
linking a plurality of collaboration affinity accounts including the affinity account owned by the customer and one or more affinity accounts owned by the one or more users such that transactions associated with the collaboration affinity accounts are summed to determine progress toward the common monetary collection goal;
receiving the donation from the at least one potential participant and applying the donation to an account associated with the benefactor;
in response to applying the donation to the account associated with the benefactor, initiating communication of information regarding the donation and information regarding progress toward the common monetary collection goal comprising a total amount of donations collected in progress toward the common monetary collection goal to the customer;
in response to applying the donation to the account associated with the benefactor, initiating communication of information regarding the donation and information regarding progress and information regarding progress toward the common monetary collection goal comprising a total amount of donations collected in progress toward the common monetary collection goal to at least one of the users of the collaboration network; and
determining the common monetary collection goal has been achieved by donations made by the collaboration network;
receiving feedback from the benefactor including information indicating an actual effect of the benefactor receiving the donations made by the collaboration network; and
in response to receiving the feedback, initiating communication to the customer and to at least one of the users of the collaboration network, at least some of the information indicating the actual effect to the benefactor of the donations made by the collaboration network.

16. The system of claim 15, wherein creating the affinity program further comprises:
proposing the affinity program to the benefactor; and
negotiating contractual terms with the benefactor on behalf of a program administrator.

17. The system of claim 16, wherein the instructions comprise an artificial intelligence engine configured for negotiating the contractual terms on behalf of the program administrator.

18. The system of claim 15, wherein the at least one potential participant is or includes the user.

19. The system of claim 15, wherein the benefactor has pre-established a plurality of affinity program creation rules; and
wherein the instructions for creating the affinity program further comprise:
instructions for determining that a number of expressions of interest from unique users surpasses a predetermined threshold; wherein the instructions further comprise:
instructions for, in response to determining the number of expressions of interest from unique users surpasses the predetermined threshold, initiating the affinity program comprising:
instructions for initiating an invitation to at least one of the users to join the affinity program.

20. The system of claim 19, wherein the benefactor pre-established the plurality of affinity program rules by negotiating the plurality of affinity program rules with a program administrator.

21. The system of claim 15, wherein a program administrator has pre-established a plurality of affinity program creation rules; and
wherein the instructions for creating the affinity program further comprise instructions for:
determining that a number of expressions of interest from unique users surpasses a predetermined threshold; wherein the instructions further comprise:
instructions for, in response to determining the number of expressions of interest from unique users surpasses the predetermined threshold, initiating the affinity program comprising:
instructions for initiating an invitation to at least one of the users to join the affinity program.

22. The system of claim 21, wherein the program administrator pre-established the plurality of affinity program rules by negotiating the plurality of affinity program rules with the benefactor.

23. The system of claim 15, wherein the instructions for creating the affinity program further comprise:
instructions for determining that a number of expressions of interest from unique users surpasses a predetermined threshold; and wherein the instructions further comprise:
instructions for proposing the affinity program to the benefactor; and
instructions for negotiating contractual terms with the benefactor on behalf of a program administrator.

24. The system of claim 23, wherein the instructions comprise an artificial intelligence engine configured for negotiating the contractual terms.

25. The system of claim 15, wherein the instructions for creating the affinity program further comprise:
instructions for receiving information indicating at least one interest of at least one of the potential participants; and
instructions for establishing a plurality of rules for governing the affinity program based at least in part on the received information.

26. The system of claim 15, wherein the instructions further comprise:
instructions for establishing a communication portal configured to receive at least one expression of interest or user recommendation regarding the affinity program.

27. The system of claim 15, wherein the instructions further comprise:
instructions for establishing, by at least one of a plurality of potential participants or current participants, a communication portal configured to interact with the benefactor.

28. The system of claim method of claim 27, wherein the communication portal is configured to facilitate negotiation between the at least one potential or current participant and the benefactor.

29. A computer program product comprising a non-transient computer-readable memory comprising instructions for creating an affinity program, the instructions comprising instructions for:
receiving an expression of interest for a benefactor from a customer;
proposing creation of an affinity program associated with the benefactor to the customer;
creating an affinity program associated with the benefactor, the creating comprising:
determining at least one triggering action for triggering a donation to the benefactor;
determining at least one potential participant for the affinity program; and
inviting the at least one potential participant to join the affinity program; and
enrolling the at least one potential participant in the affinity program;
providing a collaboration network comprising one or more users and the customer, the collaboration network configured to provide the one or more users and the customer with an opportunity to collaborate with regard to a common monetary collection goal;
linking a plurality of collaboration affinity accounts including the affinity account owned by the customer and one or more affinity accounts owned by the one or more users such that transactions associated with the collaboration affinity accounts are summed to determine progress toward the common monetary collection goal;
receiving the donation from the at least one potential participant and applying the donation to an account associated with the benefactor;
in response to applying the donation to the account associated with the benefactor, initiating communication of information regarding the donation and information regarding progress toward the common monetary collection goal comprising a total amount of donations collected in progress toward the common monetary collection goal to the customer;
in response to applying the donation to the account associated with the benefactor, initiating communication of information regarding the donation and information regarding progress and information regarding progress toward the common monetary collection goal comprising a total amount of donations collected in progress toward the common monetary collection goal to at least one of the users of the collaboration network; and
determining the common monetary collection goal has been achieved by donations made by the collaboration network;
receiving feedback from the benefactor including information indicating an actual effect of the benefactor receiving the donations made by the collaboration network; and
in response to receiving the feedback, initiating communication to the customer and to at least one of the users of the collaboration network, at least some of the information indicating the actual effect to the benefactor of the donations made by the collaboration network.
